(19) United States
(12) Patent Application Publication
(10) Pub. No.: US 2010/0143860 A1
(43) Pub. Date: Jun. 10, 2010

(54) SYSTEM FOR THE MAKING AND MEASURING OF ODONTOIATRIC ENDOCANALARS BORES FOR POSTS, AND A METHOD THEREOF

(76) Inventor: Giuseppe Corradi, Palermo (IT)

Correspondence Address: LUCAS & MERCANTI, LLP, 475 PARK AVENUE SOUTH, 15TH FLOOR, NEW YORK, NY, 10016, US

(21) Appl. No.: 12/442,014

(22) PCT Filed: Sep. 19, 2007
(86) PCT No.: PCT/IB2007/002716

§ 371 Date: Feb. 4, 2010

(30) Foreign Application Priority Data
Sep. 19, 2006 (IT) PA2006A000041
Sep. 19, 2007 (IT) PA2007A000030

(51) Int. Cl. A61C 19/04

(52) U.S. Cl. 433/74

(57) ABSTRACT

A method and a system for the making and the measuring of bores or seats (2) for endocanalar odontoiatric posts (6) in a dental root (3) is characterised in that it comprises: first milling means (100) for said dental root (3) for the making of an endocanalar duct (2) having a gauged diameter and concentricity; second milling means (1) for the making of an endocanalar duct (2) having a gauged diameter and concentricity; metering means (4) for the metering of the length of said endocanalar duct (2) inside said dental root (3); and marking means (5) onto an endocanalar post (6) of said metered length by said metering means (4).

The present invention refers to a method for the making of endocanalar bores in odontoiatric implementations and to the relevant system for the making of bores for endocanalar posts.

It is already known to the art that the glass fiber it is the most implemented material in the odontoiatric field for the re-construction of dental stumps, after being damaged by cavities or shocks. In theses cases, it is preferred the use of glass fiber alternatively to different dental alloys, since the former has a rigidity and bending modules such that to prevent braking of the root when stressed during the masticatory action. Further, the fiber is a inert and non toxic material, with respect to the alloys which are subjected to galvanic phenomena when contacting with other materials.

On the other hand, in commerce there are different kinds of posts made in glass fiber, and they are identified within two main groups, the first group comprises posts having a cylindrical shape with constant diameter, and the second group comprises posts having a non constant diameter (i.e., a varying diameter). Both groups provide that a portion of the post is designed to be inserted inside the root of the tooth to be treated, whilst the remaining portion is designed to be projecting out from the tooth for supporting the per prosthesis.

The cylindrical portion projecting out from the root and supporting the prosthesis is that having greater diameter (sometimes it has 5 times the inner portion diameter).

Therefore, it is easy to understand that a precise and correct protocol for the inserting and joining of the post to the outer base of the root (i.e., the base of the greater diameter portion following the smaller diameter portion inserted inside of the root) has to be followed, otherwise there may be a breaking of the post during masticatory action, as well as a possible detachment due to food infiltration between both surfaces. More precisely, a drawback of such technique for the implanting of a glass fiber post in a root is due to the procedure which is followed up to now:
a first flattening procedure of the outer surface of the root of the tooth (which is hand operated and having the main drawback due to the hand operation which means neither uniform nor parallel thickness; and
a rebasing by applying resin composites which are auto-or-photo hardening, and that are applied into spaces between the base of the post and the root.

On the other hand, as it is well known in the art all polymeric resins after polymerisation thereof, the same show a determined shrink degree, therefore it is easily understood that a complete and safe adhesion between post and tooth at the mating surfaces of the root it is hard to obtain.

Further, polymerised composite materials in dental applications never show same mechanical properties of a polymerised glass fiber such that in industrial applications at 200° C.

On the other hand, all dental roots show a taper ratio with a greater diameter in the direction facing upside the base of the root. Basically, this diameter it is almost ⅕ times the diameter of the stump. If the multidirectional masticatory stresses are not equally and even distributed at the point where the post changes diameter, i.e. greater cylinder becomes smaller cylinder, a breakage of the post itself may occur.

Therefore, the method and the system of the state of the art as above described has the following drawbacks:
Outer levelling which is not parallel to the root axis;
Rebasing of the mating surface (post-root) with resin composites having showing a shrinkage;
Polymerisation of a composite for the filling of empty spaces between two surfaces, the composite showing different mechanical properties from the mechanical properties of the glass fiber, thereby an imperfect junction of the parts may occur; and
Not even distribution of the multidirectional masticatory stresses along the root axis.
   These are important drawbacks which may determine a breakage or dislocation of the endocanalar post.

Aim of the present invention is to provide method for the making of endocanalar posts which solves the above described drawbacks of the state of the art, wherein the following steps are provided:
Making a first duct having a constant diameter in a dental root of a tooth by means of a first gauged mill;
Making of a plurality of coupling seats within in said endocanalar duct of said root by means of a second guiding mill;
Providing a gauge for the metering of the length of said endocanalar duct;
eventually, providing a metallic post having a analog shape of an endocanalar post within said duct of said dental root, and realising a radiography check of the mating post-root; and
providing an endocanalar post made of a synthetic material in a fixed manner within said duct root.

Another aim of the present invention is to provide a system having a plurality of tools for the making of a endocanalar duct in a dental root and for the fixing of an endocanalar post within said duct, the system comprising:
first milling means for milling said dental root and for the making of a endocanalar duct having a gauged diameter and concentricity within said root;
second milling means for milling said dental root and for the making of one or more mating seats for an endocanalar post at the upper portion of said endocanalar duct;
metering means for the metering of the length of said endocanalar duct in said root; and
checking means for the radiographic inspection of the position of said endocanalar duct in said dental root.

Therefore, the present invention provides a method and a system according to the annexed claims.

A detailed description of a preferred embodiment of the method and the system for the making of bores or ducts for endocanalar odontoiatric posts according to the present invention will be given hereinafter, as a non limiting example and with reference to the annexed drawings, wherein:

FIGS. 1 to 3 schematically show three steps of the method for the making of endocanalar bores in a dental root according to the present invention;

FIG. 4 shows a first component of the system of the present invention;

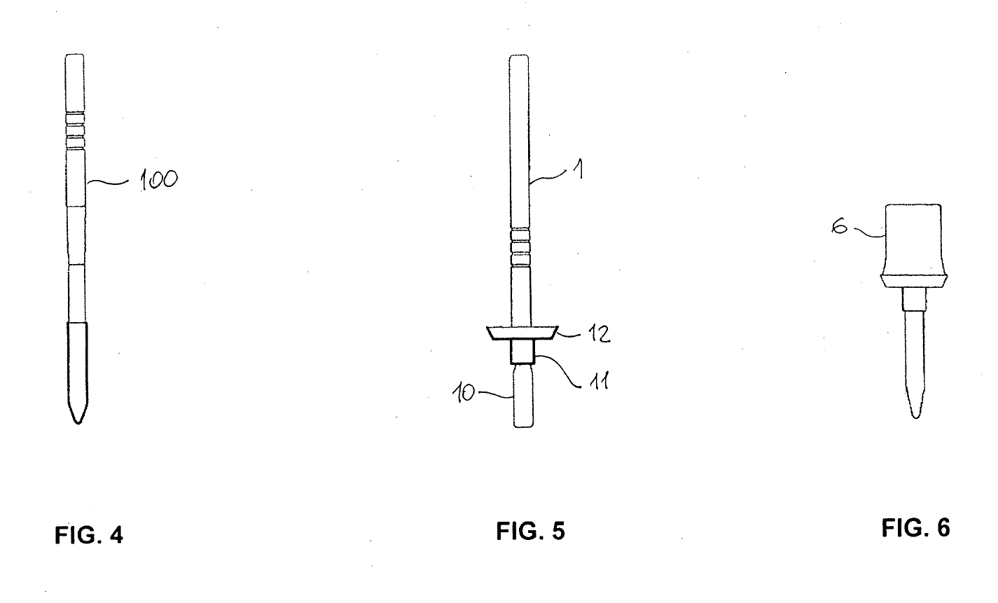

FIG. 5 shows a second component of the system of the present invention;

FIG. 6 shows a final stump;

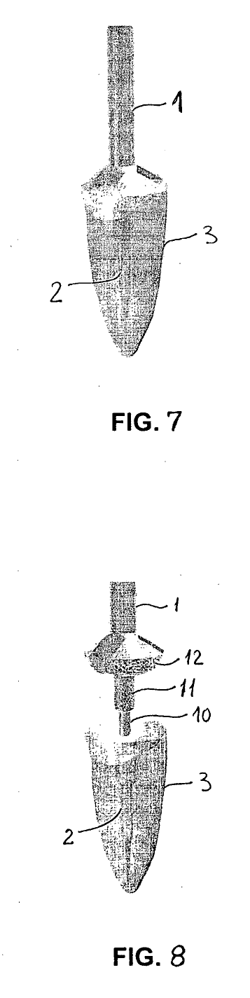

FIG. 7 schematically shows a step for the making of an endocanalar bore in a dental root according to the method of the present invention;

FIG. 8 shows another step for the making of a endocanalar bore in a dental root, according to the method of the present invention;

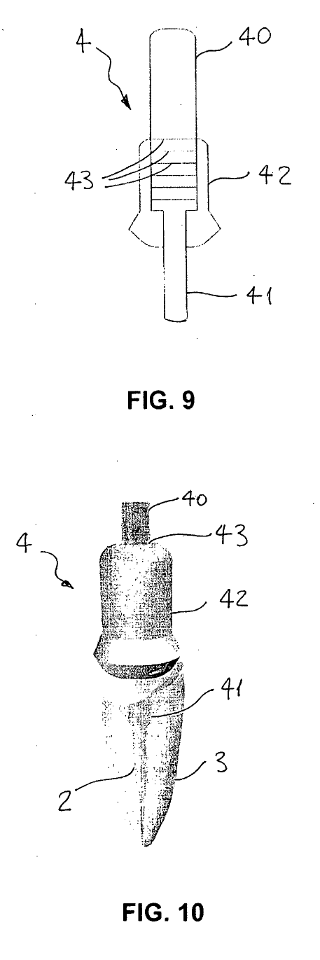

FIG. 9 shows a third component for the metering of the length of the endocanalar bore according to the system of the present invention;

FIG. 10 shows the component of the FIG. 9 in a operating condition; and

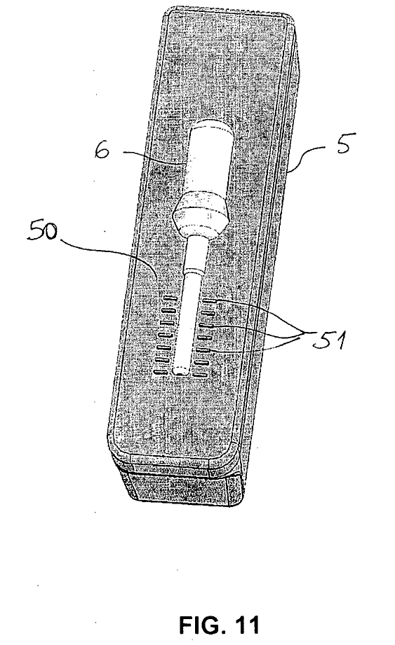

FIG. 11 shows a fourth component of the system of the present invention.

With reference now to FIG. 1 the new system provides a gauged mill 1, which thanks to its shape can realise a gauged bore 2 for what concerns diameters and concentricity in a dental root 3, therefore providing a perfect micrometrical coupling or mating between the base of a post and the outer base of said root 3 without the need of resin composites.

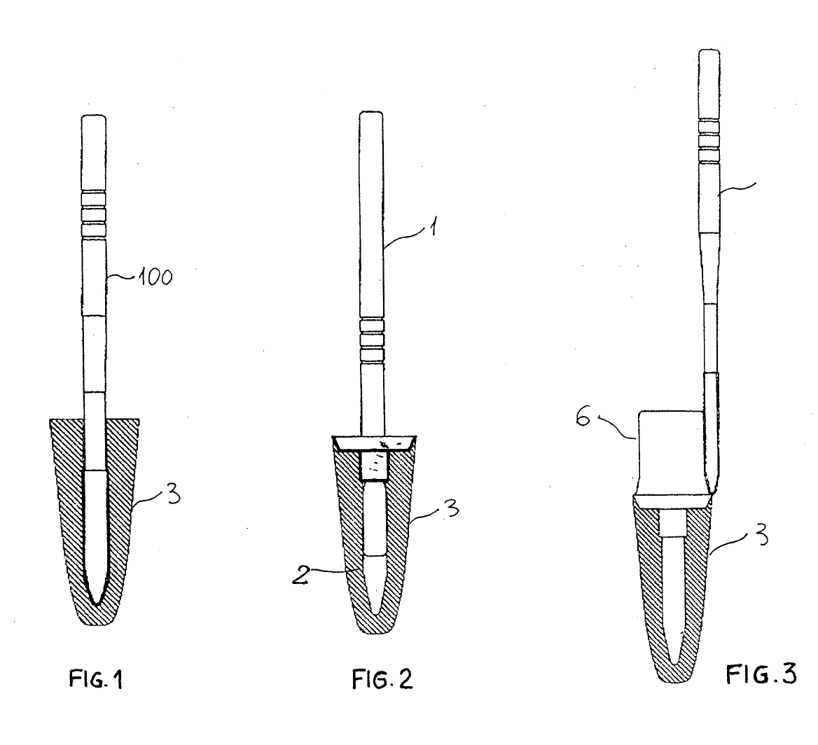

Further and with reference to FIG. 2, the mill 1 has a gauged guide, which thanks to its shape and during the milling the same realises a plurality of seats which determine a stress distribution surfaces along the root axis, improving the mechanical behaviour of the assembly of the fiber post when inserted therein (better shown hereinafter).

With reference now to FIG. 3, according to the invention is provided the use of a fiber post in a pre-modelled series. Being such a final post made in a polymerised fiber at 200° C. at factory standards, its dimensional and mechanical properties are guaranteed, therefore a perfect mating to the root it is also guaranteed.

With reference now figures from 4 to 6, a detailed description of the components of the system of the present invention will be given, and for the preparation of the root (milling operation).

With reference to FIGS. 4 and 1, in a first step is provided the use of a first gauged mill 100 which determines the making of a bore or duct 2 with a steady constant diameter inside said root 3. The bore 2 will provide a guiding duct for the second mill 1 in the subsequent step (FIG. 2).

As it is shown in FIGS. 2 and 5, subsequently to the use of said mill 100 is provided a further step by using a gauged mill 1. The mill 1 has and end thereof which realises a gauged guide 10, the latter allowing the guiding thereof in a precise and coaxial to the bore and during the whole milling operation. The mill 1 has a first cylindrical milling portion 11 and a second cup shaped milling portion 12.

The overall shape of the mill 1 determines inside the root 3 a series of mating surfaces for the post. It is here necessary to draw the attention to the fact that said mating surfaces inside the root 3 will determine a series of surfaces for the distribution of the masticatory stresses along the root axis, obtaining an improved strengthening of the whole assembly of the post-root, and an improved coupling between post and root is achieved with a perfect parallelism and concentricity.

With reference now to FIG. 6, according the method of the present invention is provided the use of a post 6 made in glass fiber. Normally, said post 6 is provided in several sizes according to the professional needs.

With reference now to FIGS. 7 and 8, it is shown the realisation steps of said endocanalar duct 2 inside said root 3 and before the inserting of said fiber post 6 therein.

More precisely, the mill 1 can be used only after the typical milling operation by means of said mill 100 (FIG. 1) where a duct or bore 2 inside said dental root 3 is achieved.

Further and with reference to FIG. 8, thanks to the particular shape of said mill 1, inside said dental root 3 a series of mating surfaces are achieved, such mating surfaces constituting stresses distributing surfaces during masticatory function along the root axis, as well as said surfaces constitute a plurality of mating seats for the post 6 when inserted inside said root 3.

With reference now to FIGS. 9 and 10, it is shown a further component according to the system of the present invention.

According to the invention, for the measuring of the precise length of the endocanalar bore 2 within said dental root 3, it is provided a gauge 4 made of an extremely hard material, such as inox steel or similar. The gauge 4 has a first cylindrical body 40 elongated shaped and having an end surface 41 which is formed in a shape which is complementary to endocanalar bore 2 realised inside said tooth 3.

Further, on the body 40 it is mounted in a sliding manner is a second cylindrical body 42, said body 42 having a mating end thereof for cooperating with said tooth 3 and being shaped in a complementary shape to said second cup shaped milling portion 12 of said mill 1, therefore being also complementary to the shape of the relevant upper surface of said dental root 3.

The body 40 has a series of parallel and equally spaced grooves 43 each of them representing a predetermined metric distance (for example, 1/10 millimetres, or similar).

With reference now to FIG. 10, for the function of said gauge 4, at first the end portion 41 it is inserted inside said bore 2 obtained by said mill mill 1 inside said dental root 3, up to abut the end portion of the body 42 in the complementary seat inside said root 3.

In this condition, the end part 41 abuts up to the maximum length of the endocanalar bore 2 allowing the opposite portion of the body 40 to expose one or more grooves 43 out from the body 42, the number of grooves exposed corresponding to the length/depth of the endocanalar bore 2 metered.

At this stage, the user can easily read and note the value of the length of the endocanalar bore so metered from the number of grooves 43 exposed.

With reference now to FIG. 11 it is shown another metering component according to the system of the present invention.

More precisely, according to the method is provided a metering and supporting member 5 for an endocanalar post 6. The metering member 5 has a metering surface 50 where a series of grooves 51 are obtained, said grooves 51 being equally spaced and corresponding to the same metering of said series of grooves 43 onto said body 40 of said gauge 4.

To the skilled men of the art it will be apparent that according to the present invention, advantageously providing said grooves 51 onto said member 5 it is possible to readily convert the reading of the exact measured length of the endocanalar bore 2 onto the post 6, by simply arranging the post 6 inside said member 5 and marking the former with the corresponding groove 51, i.e. the groove 51 corresponding to the exposed groove 43 onto said body 40 of the gauge 4 during the metering of the length of said endocanalar bore 2.

In this manner, after signalling of the exact length onto said post 6, the latter is extracted out form said body 5 and cut at the corresponding marking, obtaining an endocanalar post 6 having an exact and complementary length to endocanalar bore 2.

According to another advantageous aspect of the present invention, the gauge 4 when inserted inside the relevant endocanalar bore 2 of the dental root 3, the same will provide to the skilled man a metering member for the radiographic inspection for the coupling post-root.

1-8. (canceled)

9. A system for the making and the measuring of bores or seats (2) for endocanalar odontoiatric posts in a dental root, comprising:
first milling means for said dental root and for boring an endocanalar duct having a first gauged diameter and concentricity;
second milling means for said dental root and for the making of an endocanalar duct having a second gauged diameter and concentricity;
means for the sensing and metering the length of said endocanalar duct within said dental root; and
means for marking the metered length by said metering means onto a relevant endocanalar post.

10. A system for the making and the measuring of bores or seats for endocanalar odontoiatric posts in a dental root according to claim 9, wherein said first milling means comprises a gauged mill having an elongated and substantially constant diameter shape which represents the shape of the endocanalar bore inside said root.

11. A system for the making and the measuring of bores or seats for endocanalar odontoiatric posts in a dental root according to claim 10, wherein said second milling means comprises a guiding gauged mill, said mill having a first and a second cup shaped milling surfaces, and a guiding gauged cylindrical portion at and end thereof, said gauged cylindrical portion being of the same size of said endocanalar duct for and being movable inside said duct.

12. A system for the making and the measuring of bores or seats for endocanalar odontoiatric posts in a dental root according to claim 9, wherein said sensing and metering means comprises a gauge having:
a main elongated cylindrical body having and end thereof having a complementary shape to said endocanalar bore;
a second cylindrical body mounted onto said body in a sliding manner, said second cylindrical body having a mating end surface with a relevant tooth surface, said mating end having a shape which is complementary to the shape of said second milling surfaces of said mill;
a plurality of grooves obtained on the surface of said main body, said grooves being parallel and equally spaced of a fixed metric distance,
the arrangement being such that following to the inserting of said end into said endocanalar bore up to abut of said body onto said root one or more grooves are exposed from said body, and the number of exposed grooves corresponding to the value/measure of length of the metered endocanalar bore.

13. A system for the making and the measuring of bores or seats for endocanalar odontoiatric posts in a dental root according to claim 12, wherein said gauge is made of a extremely rigid material such as inox steel or similar.

14. A system for the making and the measuring of bores or seats for endocanalar odontoiatric posts in a dental root according to claim 9, wherein said marking means comprises a metering member for supporting an endocanalar post, said metering supporting member having a metering surface having a series of grooves equally spaced and corresponding to said grooves in said gauge.

15. A method for the making and the measuring of bores or seats for endocanalar odontoiatric posts in a dental root, comprising the following steps:
making an endocanalar bore inside a dental root having a uniform diameter by means of a guiding gauged mill according to the preceding claims;
inserting in a movable manner a gauge according to the preceding claims in said endocanalar bore and metering the length of said endocanalar bore;
inserting an endocanalar post in a metering supporting member according to the preceding claims;
marking onto said post the exact length of said endocanalar bore read onto said gauge; and
remove and cut said endocanalar post at the so marked position at the preceding step.

16. Method for the making and the measuring of bores or seats for endocanalar odontoiatric posts in a dental root according to claim 15, further comprising the step of radiographic inspection by means of said gauge.
